(19) United States
(12) Patent Application Publication
(10) Pub. No.: US 2025/0149750 A1
(43) Pub. Date: May 8, 2025

(54) BATTERY MODULE AND METHOD OF MANUFACTURING THE SAME

(71) Applicant: SK ON CO., LTD., Seoul (KR)

(72) Inventors: Hoe Min CHEONG, Daejeon (KR); Seung Ho KWAK, Daejeon (KR)

(21) Appl. No.: 18/929,616

(22) Filed: Oct. 29, 2024

(30) Foreign Application Priority Data
Nov. 7, 2023 (KR) 10-2023-0152856

(51) Int. Cl. H01M 50/516; H01M 50/505; H01M 50/528

(52) U.S. Cl. CPC H01M 50/516; H01M 50/505; H01M 50/528

(57) ABSTRACT

A battery module is disclosed. The battery module may comprise a plurality of battery cells stacked in a first direction, wherein each of the plurality of battery cells includes a cell body and an electrode lead protruding from the cell body; a busbar including a busbar body in which a plurality of busbar slits are formed, the electrode leads of the plurality of battery cells passing through the plurality of busbar slits, wherein the electrodes of the plurality of battery cells are respectively inserted into the plurality of busbar slits and are bent in the first direction to overlap with each other; and a first weld bead formed by melting and joining a portion of the busbar body and a portion of the electrode lead, the first weld bead extending in the first direction.

### CROSS-REFERENCE TO RELATED APPLICATION AND CLAIM OF PRIORITY

This application claims priority to Korean Patent Application No. 10-2023-0152856 filed on Nov. 7, 2023 in the Korean Intellectual Property Office (KIPO), the entire disclosure of which is incorporated by reference herein.

### TECHNICAL FIELD

The present disclosure relates to a battery module and a method of manufacturing the same.

### BACKGROUND

A battery cell may include a cell body and an electrode lead protruding from the cell body. The electrode lead of the battery cell may be fixed to a busbar. For example, the electrode lead of the battery cell may be positioned in a slit of the busbar and may be welded and coupled. In this case, an area where the electrode lead and the busbar are welded may be somewhat limited.

### SUMMARY

According to an aspect of the present disclosure, there are provided a battery module and a method of manufacturing the same in which electrode leads of a plurality of battery cells and a busbar are overlapped and weld-joined.

A battery module according to the present disclosure may comprise a plurality of battery cells stacked in a first direction, wherein each of the plurality of battery cells includes a cell body and an electrode lead protruding from the cell body; a busbar including a busbar body in which a plurality of busbar slits are formed, the electrode leads of the plurality of battery cells passing through the plurality of busbar slits, wherein the electrodes of the plurality of battery cells are respectively inserted into the plurality of busbar slits and are bent in the first direction to overlap with each other; and a first weld bead formed by melting and joining a portion of the busbar body and a portion of the electrode lead, the first weld bead extending in the first direction.

In a method of manufacturing a battery module assembling a plurality of battery cells and a busbar unit in accordance with the present disclosure, each of the plurality of battery cells including a cell body and an electrode lead protruding from the cell body, the busbar unit including a busbar body in which a plurality of busbar slits are formed, the method may comprise coupling the busbar unit to the battery cell, and welding the electrode lead to the busbar unit, wherein coupling the busbar unit to the battery cell may comprise inserting the electrode lead into the busbar slit, and bending the electrode lead.

According to a battery module and a method of manufacturing the same according to an embodiment of the present disclosure, electrode leads of a plurality of battery cells and a busbar can be overlapped and weld-joined.

A battery module and a method of manufacturing the same according to some embodiments of the present disclosure can be widely applied in green technology fields such as electric vehicles, battery charging stations, and other battery-based solar power generation and wind power generation.

A battery module and a method of manufacturing the same according to some embodiments of the present disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery module according to an embodiment of the present disclosure.

FIG. 2 illustrates a busbar support of a busbar unit illustrated in FIG. 1.

FIG. 3 illustrates a busbar of a busbar unit illustrated in FIG. 1.

FIG. 4 illustrates a busbar unit.

FIG. 5 illustrates a battery cell.

FIG. 6 illustrates that a busbar including a busbar body is coupled to a battery cell.

FIG. 7 is a cross-sectional view illustrating that electrode leads of a plurality of battery cells illustrated in FIG. 6 are bent after being inserted into busbars.

FIG. 8 illustrates that a laser beam is applied to an electrode lead illustrated in FIG. 7 to form a weld bead.

FIG. 9 illustrates an electrode lead and a busbar illustrated in FIG. 8 when viewing from the outside of the busbar.

FIG. 10 illustrates that a busbar including a busbar body and a busbar cover is coupled to a battery cell.

FIG. 11 illustrates a busbar including a busbar cover.

FIG. 12 is a cross-sectional view illustrating that electrode leads of a plurality of battery cells illustrated in FIG. 11 are inserted into busbar slits and bent, and then are covered by a busbar cover.

FIG. 13 is a cross-sectional view illustrating that electrode leads of a plurality of battery cells illustrated in FIG. 11 are inserted into busbar slits and bent, and then are covered by a busbar cover forming a stepped portion.

FIG. 14 illustrates that a laser beam is applied to a busbar cover illustrated in FIG. 12 to form a weld bead.

FIG. 15 illustrates a busbar and a weld bead illustrated in FIG. 14 when viewing from the outside of the busbar.

FIG. 16 illustrates that a plurality of electrode leads are divided into two groups and are stacked, as a form of an electrode lead and a busbar illustrated in FIG. 8 when viewing from the outside of the busbar.

FIGS. 17 and 18 illustrate that a weld bead is formed using a zig.

### DETAILED DESCRIPTION OF THE EMBODIMENTS

Reference will now be made in detail to embodiments of the present disclosure, examples of which are illustrated in the accompanying drawings. However, the following description is merely an example and does not intend to limit the present disclosure to a specific implementation.

A battery module according to the present disclosure can be applied to a pouch cell, a cylindrical cell, a square cell, etc. An electrode assembly can be a winding type, a stacking type, a zigzag-folding (z-folding) type, or a stack-folding type.

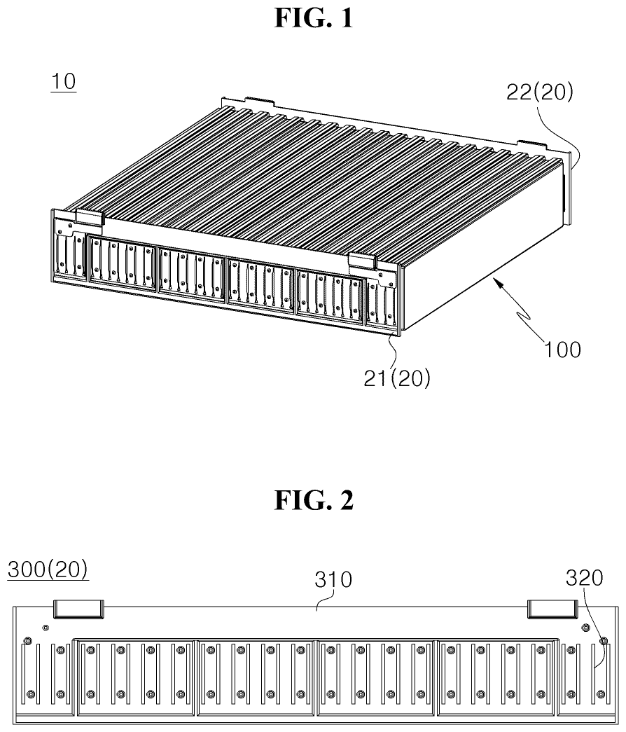

FIG. 1 illustrates a battery module according to an embodiment of the present disclosure. Referring to FIG. 1, a battery module 10 may include at least one battery cell 100. For example, the battery module 10 may include a plurality of battery cells 100. The plurality of battery cells 100 may be stacked in one direction. For example, the plurality of battery cells 100 may be stacked in a horizontal direction. The plurality of battery cells 100 may be accommodated in a case (not shown).

The battery module 10 may include a busbar unit 20. For example, the busbar unit 20 may electrically connect the plurality of battery cells 100. The busbar unit 20 may be coupled to the plurality of battery cells 100. At least a portion of the busbar unit 20 may be accommodated in a case (not shown).

A plurality of busbar units 20 may be provided. For example, the battery module 10 may include a plurality of busbar units 20. For example, the battery module 10 may include a first busbar unit 21 and a second busbar unit 22. The busbar unit 20 may include or indicate at least one of the first busbar unit 21 and the second busbar unit 22.

FIG. 2 illustrates a busbar support of a busbar unit illustrated in FIG. 1.

Referring to FIG. 2, the busbar unit 20 may include a busbar support 300. The busbar support 300 may include a busbar support body 310. The busbar support body 310 may face a portion of each of the plurality of battery cells 100 (see FIG. 1).

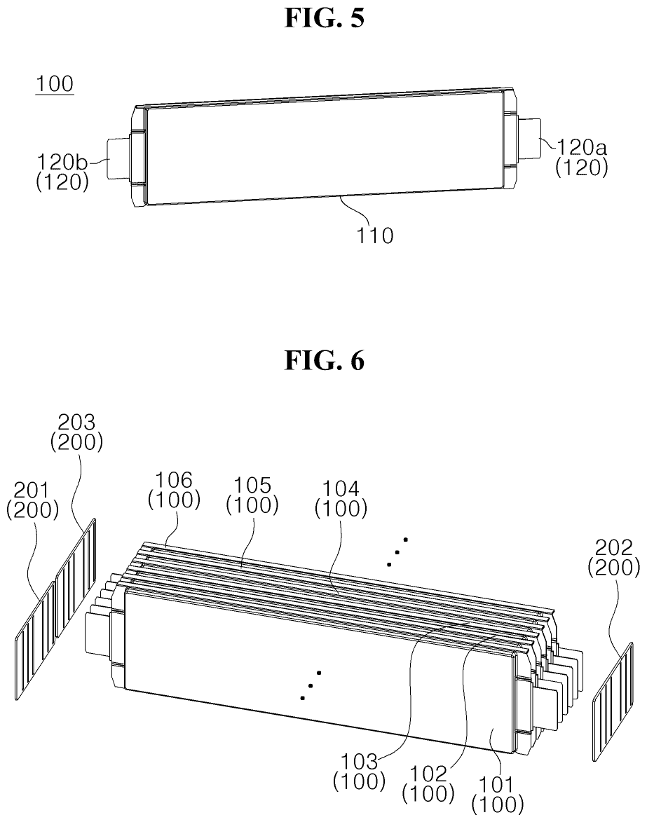

For example, the busbar support body 310 may face a cell body 110 (see FIG. 5) of each of the plurality of battery cells 100 (see FIG. 1). For example, the busbar support body 310 may face an end of the cell body 110 (see FIG. 5) of each of the plurality of battery cells 100 (see FIG. 1). An electrode lead 120 (see FIG. 5) may protrude from an end of a cell body 110 (see FIG. 5).

The busbar support body 310 may form a plate or a board shape. For example, the busbar support body 310 may form an inner surface and an outer surface. For example, the inner surface of the busbar support body 310 may face the end of the cell body 110 (see FIG. 5) of each of the plurality of battery cells 100 (see FIG. 1).

The busbar support body 310 may be formed of a material including an electrically insulating material. For example, the busbar support body 310 may be formed of a material including a polymer or a plastic.

The busbar support body 310 may have an elongated shape in one direction. For example, the busbar support body 310 may extend from an end and lead to another end. A direction in which the busbar support body 310 extends may be parallel to a direction in which the plurality of battery cells 100 (see FIG. 1) are stacked. That is, the busbar support body 310 may have an elongated shape in the direction in which the plurality of battery cells 100 (see FIG. 1) are stacked.

The busbar support 300 may include a busbar support slit 320. The busbar support slit 320 may be a slit formed in the busbar support body 310. The busbar support slit 320 may form an elongated shape in an up-down direction. The busbar support slit 320 may be connected to the inner surface and the outer surface of the busbar support body 310.

A plurality of busbar support slits 320 may be provided. The plurality of busbar support slits 320 may be sequentially arranged spaced apart in one direction. For example, the plurality of busbar support slits 320 may be sequentially arranged in the direction in which the plurality of battery cells (100, see FIG. 1) are stacked.

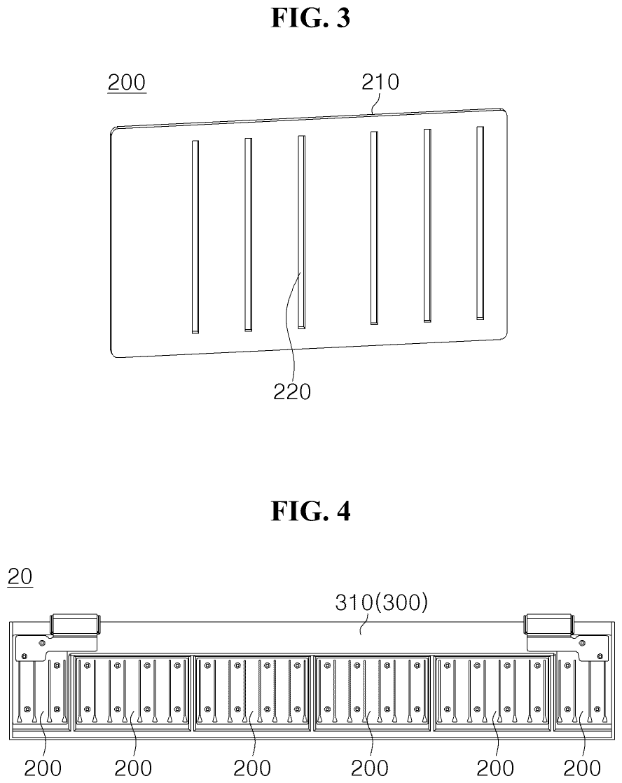

FIG. 3 illustrates a busbar of a busbar unit illustrated in FIG. 1. The busbar unit 20 (see FIG. 1) may include a busbar 200. A plurality of busbars 200 may be provided. The plurality of busbars 200 may be arranged to be spaced apart in a direction in which the busbar support 300 (see FIG. 2) extends. For example, the plurality of busbars 200 may be sequentially arranged to be spaced apart in the direction in which the plurality of battery cells 100 (see FIG. 1) are stacked.

The busbar 200 may include a busbar body 210. The busbar body 210 may be formed of a material including an electrically conductive material. For example, the busbar body 210 may be formed of a material including a metal.

The busbar body 210 may form a plate or board shape. For example, the busbar body 210 may form an inner surface and an outer surface. For example, the inner surface of the busbar body 210 may face or contact an outer surface of the busbar support 300 (see FIG. 2).

The busbar 200 may include a busbar slit 220. The busbar slit 220 may be a slit formed in the busbar body 210. The busbar slit 220 may form an elongated shape in the up-down direction. The busbar slit 220 may be connected to the inner surface and the outer surface of the busbar body 210.

A plurality of busbar slits 220 may be provided. The plurality of busbar slits 220 may be sequentially arranged in one direction. For example, the busbar support slits 220 may be sequentially arranged in the direction in which the plurality of battery cells 100 (see FIG. 1) are stacked.

FIG. 4 illustrates a busbar unit.

Referring to FIGS. 2 to 4, the busbar support 300 may be disposed between the cell body 110 (see FIG. 5) and the busbar 200. The busbar support 300 may electrically insulate the cell body 110 (see FIG. 5) and the busbar 200.

The plurality of busbars 200 may be connected or coupled to the busbar support 300. For example, an inner surface of each of the plurality of busbars 200 may face the outer surface of the busbar support 300 or may be coupled to the outer surface of the busbar support 300.

The busbar slit 220 and the busbar support slit 320 may face, be connected to, or communicate with each other. The electrode lead 120 (see FIG. 5) protruding from the end of the cell body 110 (see FIG. 5) may be sequentially inserted into the busbar support slit 320 and the busbar slit 220.

FIG. 5 illustrates a battery cell.

Referring to FIG. 5, the battery cell 100 may include the cell body 110. The cell body 110 may be elongated in one direction. For example, the cell body 110 may extend from a first end and lead to a second end. The first end and the second end of the cell body 110 may be positioned opposite each other.

The cell body 110 may include an electrode assembly (not shown). The cell body 110 may include a pouch that surrounds the electrode assembly (not shown).

The electrode assembly (not shown) may have electric energy. For example, the electric energy of the electrode assembly (not shown) of the cell body 110 may increase in a process of charging the battery cell 100. For example, the electric energy of the electrode assembly (not shown) of the cell body 110 may decrease in a process of discharging the battery cell 100.

The battery cell 100 may include the electrode lead 120. The electrode lead 120 may be connected to the cell body 110. For example, the electrode lead 120 may extend or protrude from the cell body 110.

The electrode lead 120 may be formed of a material including a metal. For example, the electrode lead 120 may be formed of a metal plate. The electrode lead 120 may be bent or curved. The electrode lead 120 may be coupled to another metal by welding.

For example, the battery cell 100 may include a plurality of electrode leads 120. For example, the battery cell 100 may include a first electrode lead 120a and a second electrode lead 120b. The electrode lead 120 may include or indicate at least one of the first electrode lead 120a and the second electrode lead 120b.

For example, the first electrode lead 120a may extend or protrude from the first end of the cell body 110. For example, the second electrode lead 120b may extend or protrude from the second end of the cell body 110.

For example, the first electrode lead 120a and the second electrode lead 120b may be positioned opposite each other. For example, the first electrode lead 120a and the second electrode lead 120b may protrude or extend in opposite directions from the cell body 110.

The first electrode lead 120a and the second electrode lead 120b may have different polarities. For example, the first electrode lead 120a may be an anode, and the second electrode lead 120b may be a cathode. For another example, the first electrode lead 120a may be a cathode, and the second electrode lead 120b may be an anode.

FIG. 6 illustrates that a busbar including a busbar body is coupled to a battery cell.

Referring to FIG. 6, the plurality of busbars 200 may be provided. For example, the busbar unit 20 (see FIG. 1) may include the plurality of busbars 200. For example, the busbar unit 20 (see FIG. 1) may include a first busbar 201, a second busbar 202, and a third busbar 203. The busbar 200 may include or indicate at least one of the first busbar 201, the second busbar 202, and the third busbar 203.

The plurality of battery cells 100 may be provided. For example, the battery module 10 (see FIG. 1) may include the plurality of battery cells 100. For example, the battery module 10 (see FIG. 1) may include a first battery cell 101, a second battery cell 102, a third battery cell 103, a fourth battery cell 104, a fifth battery cell 105, and a sixth battery cell 106.

The battery cell 100 may include or indicate at least one of the first battery cell 101, the second battery cell 102, the third battery cell 103, the fourth battery cell 104, the fifth battery cell 105, and the sixth battery cell 106.

The battery cell 100 may be connected to the busbar 200. For example, the electrode lead 120 (see FIG. 5) of the battery cell 100 may be inserted or fitted into the busbar slit 220 (see FIG. 3) formed in the busbar 200.

For example, the second electrode lead 120b (see FIG. 5) of each of the first battery cell 101, the second battery cell 102, and the third battery cell 103 may be coupled to the first busbar 201.

For example, the first electrode lead 120a (see FIG. 5) of each of the first battery cell 101, the second battery cell 102, and the third battery cell 103 may be coupled to the second busbar 202.

For example, the first electrode lead 120a (see FIG. 5) of each of the fourth battery cell 104, the fifth battery cell 105, and the sixth battery cell 106 may be coupled to the second busbar 202.

For example, the second electrode lead 120b (see FIG. 5) of each of the fourth battery cell 104, the fifth battery cell 105, and the sixth battery cell 106 may be coupled to a third busbar 203.

Hence, the plurality of battery cells 100 may be connected in parallel and in series. For example, the first battery cell 101, the second battery cell 102, and the third battery cell 103 may be connected in parallel and may be referred to as a “first battery cell group.”

For example, the fourth battery cell 104, the fifth battery cell 105, and the sixth battery cell 106 may be connected in parallel and may be referred to as a “second battery cell group.” The first battery cell group and the second battery cell group may be connected in series.

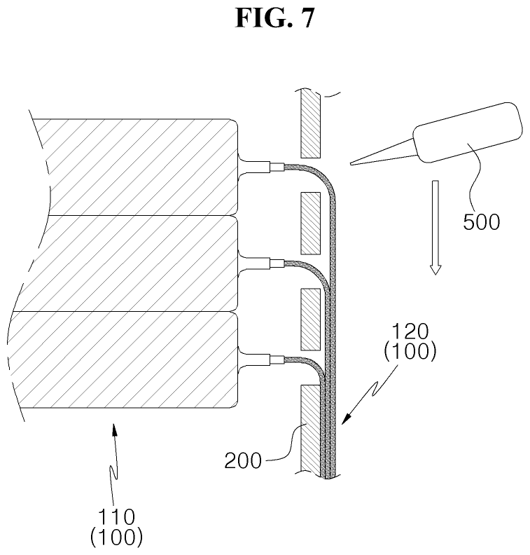

FIG. 7 is a cross-sectional view illustrating that electrode leads of a plurality of battery cells illustrated in FIG. 6 are bent after being inserted into busbars.

Referring to FIG. 7, the electrode lead 120 extended from the cell body 110 may be bent after being inserted into the busbar slit 220 (see FIG. 3) of the busbar 200. A direction in which the electrode lead 120 is bent may be the direction in which the plurality of battery cells 100 are stacked. For example, the electrode lead 120 may be bent in the direction in which the cell bodies 110 of the plurality of battery cells 100 are stacked.

For example, the bent electrode lead 120 may face or contact an outer surface of the busbar 200. The electrode leads 120 of the plurality of battery cells 100 may overlap with each other when the electrode leads 120 are inserted into the busbar slits 220 (see FIG. 3) and bent.

In a state where the electrode leads 120 are bent and overlap with each other while facing the busbar 200, a laser 500 may apply a laser beam to the electrode leads 120. For example, the laser 500 may apply the laser beam to the electrode leads 120 from the outside of the busbar 200.

A direction in which the laser 500 applies the laser beam to the electrode lead 120 from the outside of the busbar 200 may form an angle with a direction in which the outer surface of the busbar 200 faces. For example, even if the laser beam is directed toward the busbar slit 220 (see FIG. 3) in a state where the electrode lead 120 is not coupled to the busbar 200, the laser beam may not pass through the busbar slit 220 (see FIG. 3).

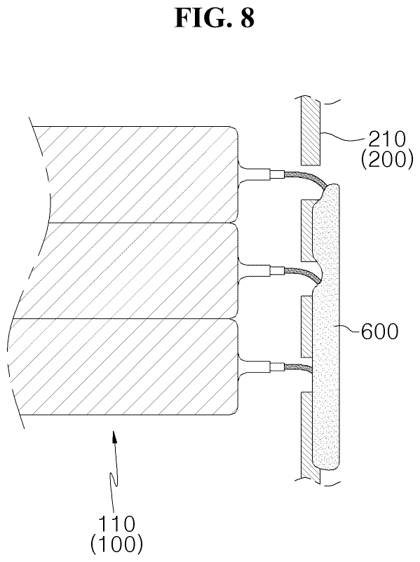

FIG. 8 illustrates that a laser beam is applied to an electrode lead illustrated in FIG. 7 to form a weld bead.

Referring to FIGS. 7 and 8, when the laser beam is applied to the electrode lead 120, thermal energy may be transferred to the electrode lead 120. A portion of the thermal energy applied to the electrode lead 120 may be transferred to the busbar body 210. Through this process, the electrode lead 120 and the busbar body 210 may be coupled.

Therefore, a method of coupling the electrode lead 120 and the busbar 200 according to an embodiment of the present disclosure is different from a method in which the electrode leads 120 of the plurality of battery cells 100 are individually coupled to the busbar 200.

For example, the electrode leads 120 of the plurality of battery cells 100 and the busbar 200 may form one weld bead 600. For example, the weld bead 600 may be formed by melting and joining a portion of the busbar 200 and a portion of the electrode lead 120 and then solidifying it.

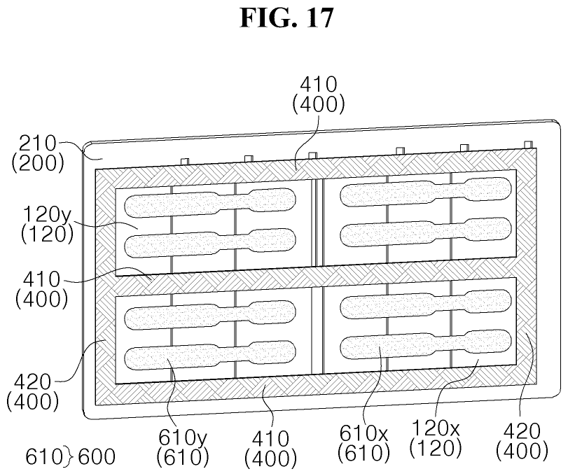

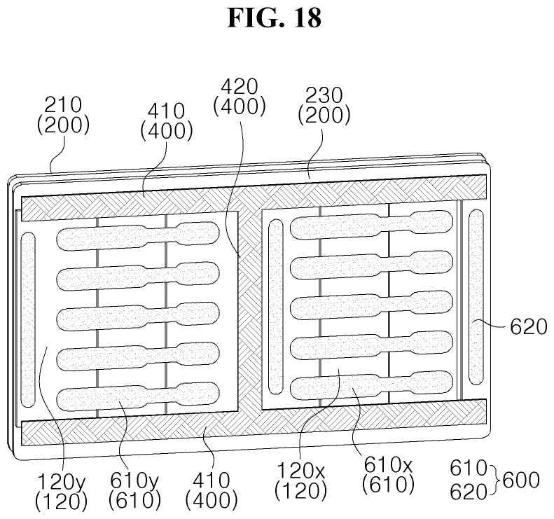

For example, a first weld bead 610 (see FIG. 17) may be formed by melting and joining a portion of the busbar body 210 and a portion of the electrode lead 120 and then solidifying it. As another example, the first weld bead 610 (see FIG. 18) may be formed by melting and joining a portion of the busbar body 210, a portion of a busbar cover 230 (see FIG. 18), and a portion of the electrode lead 120 and then solidifying it. A second weld bead 620 (see FIG. 18) may be formed by melting and joining a portion of the busbar body 210 and a portion of the busbar cover 230 (see FIG. 18) and then solidifying it. The weld bead 600 may include or indicate at least one of the first weld bead 610 (see FIG. 17) and the second weld bead 620 (see FIG. 18).

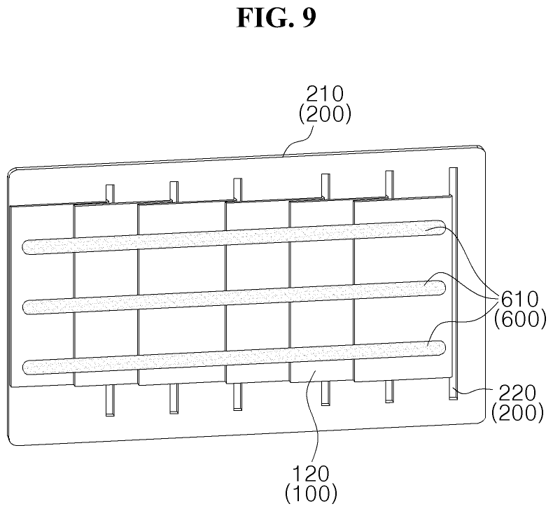

FIG. 9 illustrates an electrode lead and a busbar illustrated in FIG. 8 when viewing from the outside of the busbar.

Referring to FIG. 9, the weld bead 600 may include the first weld bead 610. The first weld bead 610 may form an elongated shape in one direction. For example, the first weld bead 610 may form an elongated shape in a direction in which the cell bodies 110 of the plurality of battery cells 100 (see FIG. 8) are stacked.

A plurality of first weld beads 610 may be provided. The plurality of first weld beads 610 may be spaced apart from each other. For example, the weld bead 600 may include the plurality of first weld beads 610. The plurality of first weld beads 610 may be arranged in a longitudinal direction of the busbar slit 220.

The longitudinal direction of the busbar slit 220 may be a width direction of the cell body 110 (see FIG. 5). For example, the width direction of the cell body 110 (see FIG. 5) may intersect a direction in which the cell bodies 110 (see FIG. 5) are stacked. The stacking direction of the cell body 110, (see FIG. 5) may be a thickness direction of the cell body 110 (see FIG. 5).

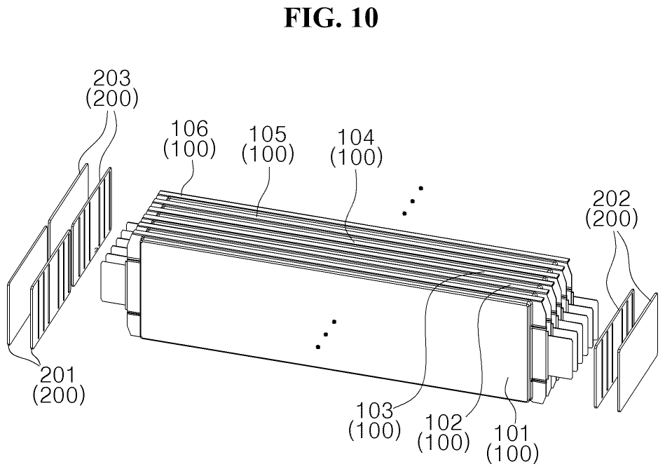

FIG. 10 illustrates that a busbar including a busbar body and a busbar cover is coupled to a battery cell.

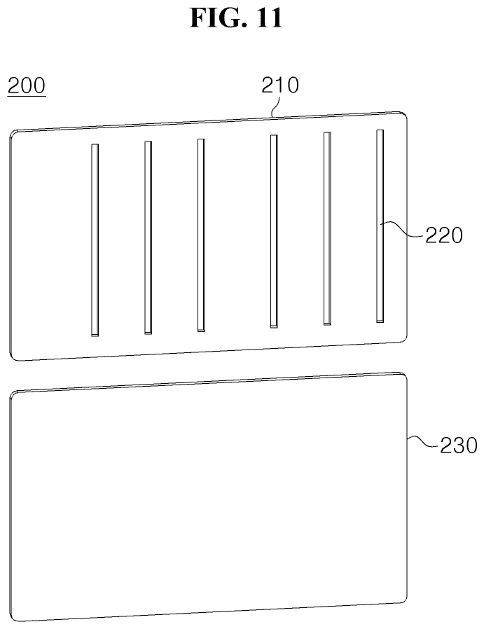

Referring to FIG. 10, the busbar 200 may include the busbar body 210 and the busbar cover 230. The busbar cover 230 may cover the electrode lead 120 (see FIG. 5) after the electrode lead 120 (see FIG. 5) is inserted into the busbar slit 220 (see FIG. 11) and bent. A coupling relationship between the busbar body 210 and the electrode lead 120 (see FIG. 5) illustrated in FIG. 10 may be substantially the same as a coupling relationship between the busbar body 210 and the electrode lead 120 (see FIG. 5) illustrated in FIG. 6.

FIG. 11 illustrates a busbar including a busbar cover. The busbar body 210 and the busbar slit 220 illustrated in FIG. 11 may be substantially the same as the busbar body 210 and the busbar slit 220 illustrated in FIG. 3, respectively.

Referring to FIG. 11, the busbar 200 may include the busbar cover 230. The busbar cover 230 may have a plate or board shape as a whole.

The busbar cover 230 may be formed of a material including a metal. For example, the material forming the busbar cover 230 may be substantially the same as the material forming the busbar body 210. The busbar cover 230 may be welded.

The busbar cover 230 may face the busbar body 210. The busbar cover 230 may face and cover the outer surface of the busbar body 210. For example, after the electrode lead 120 (see FIG. 5) is inserted into the busbar slit 220 and bent, the busbar cover 230 may cover the busbar body 210 and the electrode lead 120 (see FIG. 5) at the outer surface of the busbar body 210.

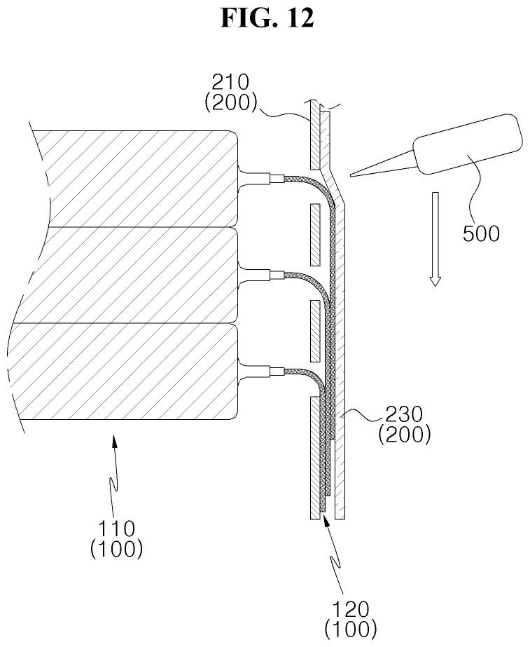

FIG. 12 is a cross-sectional view illustrating that electrode leads of a plurality of battery cells illustrated in FIG. 11 are inserted into busbar slits and bent, and then are covered by a busbar cover.

Referring to FIG. 12, the electrode lead 120 extended from the cell body 110 may be bent after being inserted into the busbar slit 220 (see FIG. 3) of the busbar 200. A direction in which the electrode lead 120 is bent may be the direction in which the plurality of battery cells 100 are stacked. For example, the electrode lead 120 may be bent in the direction in which the cell bodies 110 of the plurality of battery cells 100 are stacked. The direction in which the cell bodies 110 of the plurality of battery cells 100 are stacked may be referred to as a “first direction.”

In a state where the electrode leads 120 are bent, the busbar cover 230 may cover the electrode leads 120. An inner surface of the busbar cover 230 may face the outer surface of the busbar body 210. A portion of the busbar cover 230 may face and contact the outer surface of the busbar body 210.

A portion of the electrode lead 120 may be positioned between the busbar body 210 and the busbar cover 230. For example, an end of the electrode lead 120 may be positioned between the busbar body 210 and the busbar cover 230.

For example, a distal end portion of the electrode lead 120 may be positioned between the busbar body 210 and the busbar cover 230. A proximal end portion of the electrode lead 120 may be connected to the cell body 110 or extended from the cell body 110.

For example, the distal end portions of two electrode leads 120 respectively extended from two adjacent cell bodies 110 may overlap each other. The distal end portions of the two overlapped electrode leads 120 may be joined by welding.

In a state where a portion of the electrode lead 120 is positioned between the busbar body 210 and the busbar cover 230, the laser 500 may apply a laser beam to the busbar cover 230. For example, the laser 500 may apply the laser beam to an outer surface of the busbar cover 230.

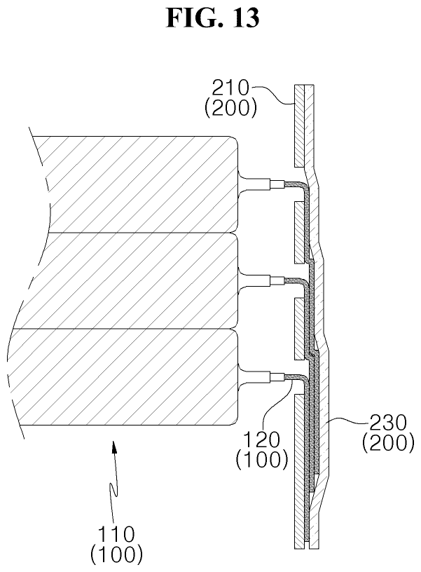

FIG. 13 is a cross-sectional view illustrating that electrode leads of a plurality of battery cells illustrated in FIG. 11 are inserted into busbar slits and bent, and then are covered by a busbar cover forming a stepped portion.

The busbar cover 230 may form a stepped portion. The electrode lead 120 may be positioned between the busbar body 210 and the busbar cover 230. The number of electrode leads 120 positioned between the busbar body 210 and the busbar cover 230 may vary depending on the position of the busbar cover 230.

The electrode lead 120 may have a thickness. Thus, a distance between the busbar body 210 and the busbar cover 230 may vary depending on the number of electrode leads 120 positioned between the busbar body 210 and the busbar cover 230.

The busbar cover 230 may form a stepped portion based on the number of electrode leads 120 positioned between the busbar body 210 and the busbar cover 230. At least one electrode lead 120 positioned between the busbar body 210 and the busbar cover 230 may be in close contact with the busbar body 210 and the busbar cover 230 as a whole.

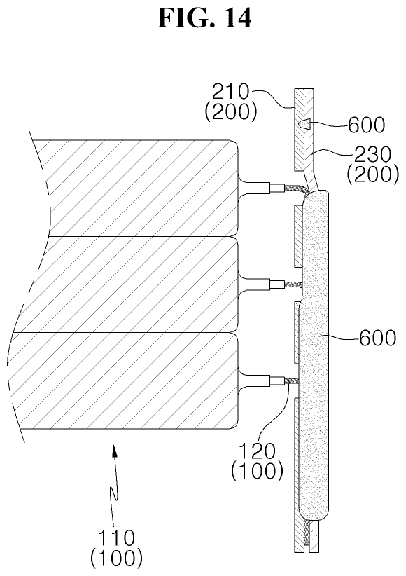

FIG. 14 illustrates that a laser beam is applied to a busbar cover illustrated in FIG. 12 to form a weld bead.

Referring to FIGS. 12 and 14, when a laser beam is applied to the busbar cover 230, thermal energy may be transferred to the busbar cover 230. A portion of the thermal energy applied to the busbar cover 230 may be transferred to the electrode lead 120 and the busbar body 210. Through this process, the electrode lead 120 may be coupled to the busbar body 210 and the busbar cover 230.

For example, the electrode leads 120, the busbar bodies 210, and the busbar covers 230 of the plurality of battery cells 100 may form the weld bead 600. In addition, the busbar body 210 and the busbar cover 230 may form a new weld bead 600.

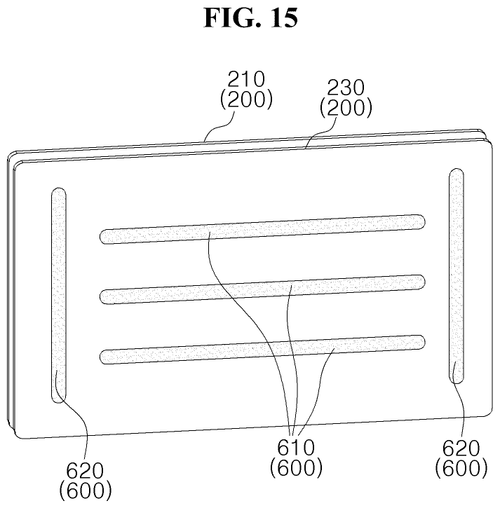

FIG. 15 illustrates a busbar and a weld bead illustrated in FIG. 14 when viewing from the outside of the busbar.

Referring to FIG. 15, the weld bead 600 may include the first weld bead 610 and the second weld bead 620. An elongated direction of the first weld bead 610 may intersect an elongated direction of the second weld bead 620.

For example, the first weld bead 610 may form an elongated shape in the direction in which the cell bodies 110 of the plurality of battery cells 100 (see FIG. 8) are stacked. For example, the first weld bead 610 may be elongated in a transverse direction.

For example, the second weld bead 620 may form an elongated shape in the longitudinal direction of the busbar slit 220. For example, the second weld bead 620 may be elongated in the width direction of the cell body 110 (see FIG. 5). For example, the second weld bead 620 may be elongated in the longitudinal direction.

A plurality of first weld beads 610 may be provided. The plurality of first weld beads 610 may be spaced apart from each other. The plurality of first weld beads 610 may be arranged in the longitudinal direction of the second weld bead 620. The plurality of first weld beads 610 may be arranged between a pair of second weld beads 620.

A plurality of second weld beads 620 may be provided. The plurality of second weld beads 620 may be spaced apart from each other. The plurality of second weld beads 620 may be arranged in the longitudinal direction of the first weld bead 610.

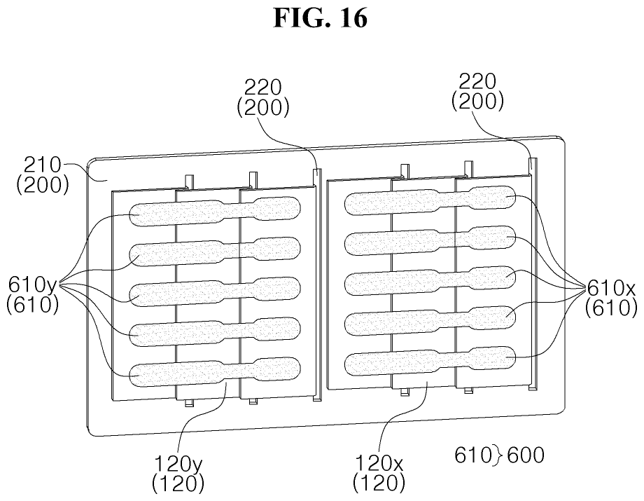

FIG. 16 illustrates that a plurality of electrode leads are divided into two groups and are stacked, as a form of an electrode lead and a busbar illustrated in FIG. 8 when viewing from the outside of the busbar.

Referring to FIG. 16, the plurality of electrode leads 120 may be classified into a first electrode lead group 120x and a second electrode lead group 120y. Each of the first electrode lead group 120x and the second electrode lead group 120y may individually include a plurality of electrode leads 120.

The plurality of electrode leads 120 belonging to the first electrode lead group 120x may be spaced apart from the plurality of electrode leads 120 belonging to the second electrode lead group 120y. In other words, the plurality of electrode leads 120 belonging to the first electrode lead group 120x may be separated from the plurality of electrode leads 120 belonging to the second electrode lead group 120y.

The first electrode lead group 120x and the second electrode lead group 120y may be individually coupled to the busbar body 210 by the weld bead 600. For example, the electrode leads 120 belonging to the first electrode lead group 120x may be coupled to the busbar body 210 by a first weld bead group 610x. For example, the electrode leads 120 belonging to the second electrode lead group 120y may be coupled to the busbar body 210 by a second weld bead group 610y.

The weld beads 600 may form the longitudinal direction as the laser beam generated by the laser 500 (see FIG. 7) moves. For example, the weld beads 600 may form the longitudinal direction while the laser 500 (see FIG. 7) moves.

An output of the laser 500 (see FIG. 7) may vary depending on at least one of time and location.

For example, the output of the laser 500 (see FIG. 7) may show a decreasing trend as the laser 500 goes from left to right based on the busbar 200 illustrated in FIG. 16, and the output of the laser 500 (see FIG. 7) may reach zero or below the lowest output before the laser beam reaches the busbar slit 220 not covered by the electrode lead 120.

After the laser 500 passes the busbar slit 220 not covered by the electrode lead 120, the output of the laser 500 (see FIG. 7) may show a decreasing trend after reaching the highest output, and the output of the laser 500 (see FIG. 7) may reach zero or below the lowest output before the laser beam reaches another busbar slit 220 not covered by the electrode lead 120.

FIGS. 17 and 18 illustrate that a weld bead is formed using a zig.

Referring to FIG. 17 and FIG. 18, a jig 400 may cover the busbar 200. For example, the jig 400 may cover the busbar body 210 and the electrode lead 120. For example, the jig 400 may cover the busbar cover 230.

The jig 400 may include a jig horizontal portion 410. The jig horizontal portion 410 may form an elongated shape in one direction. For example, the jig horizontal portion 410 may be elongated in the direction in which the plurality of busbar slits 220 (see FIG. 3) are arranged. The jig horizontal portion 410 may have a bar shape.

The jig 400 may include a jig vertical portion 420. The jig vertical portion 420 may form an elongated shape in another direction. For example, the jig vertical portion 420 may be elongated in the longitudinal direction of the busbar slit 220 (see FIG. 3). The jig vertical portion 420 may have a bar shape.

The jig horizontal portion 410 and the jig vertical portion 420 may meet or be coupled to each other. The jig vertical portion 420 may cover the busbar slit 220 not covered by the electrode lead 120. As a result, the laser beam can be prevented from passing through the busbar slit 220 and reaching the cell body 110 (see FIG. 5).

With reference to FIGS. 1 to 18, a method of manufacturing the battery module may be considered.

A method of manufacturing a battery module according to an embodiment of the present disclosure may include a step of coupling a busbar unit 20 to a battery cell 100. In the step of coupling the busbar unit 20 to the battery cell 100, the busbar unit 20 may be coupled to an electrode lead 120 of the battery cell 100.

The step of coupling the busbar unit 20 to the battery cell 100 may include a step of inserting the electrode lead 120 into a busbar slit 220. In the step of inserting the electrode lead 120 into the busbar slit 220, an end of the electrode lead 120 may be inserted into the busbar slit 220 and may pass through the busbar slit 220.

The step of coupling the busbar unit 20 to the battery cell 100 may include a step of bending the electrode lead 120. In the step of bending the electrode lead 120, the electrode lead 120 may be bent in the busbar slit 220. For example, in the step of bending the electrode lead 120, the electrode lead 120 may be bent in a direction in which the cell bodies 110 of the plurality of battery cells 100 are stacked. In the step of bending the electrode lead 120, the plurality of electrode leads 120 may be overlapped.

The step of coupling the busbar unit 20 to the battery cell 100 may include a step in which a busbar cover 230 covers the electrode lead 120. In the step in which the busbar cover 230 covers the electrode lead 120, the busbar cover 230 may face the busbar body 210 while covering the electrode lead 120.

The method of manufacturing the battery module according to an embodiment of the present disclosure may include a step of welding the busbar unit 20 to the electrode lead 120. In the step of welding the busbar unit 20 to the electrode lead 120, at least one of the busbar body 210 and the busbar cover 230 may be welded to the electrode lead 120. In the step of welding the busbar unit 20 to the electrode lead 120, a weld bead 600 may be formed.

The step of welding the busbar unit 20 to the electrode lead 120 may include a step of positioning a jig 400 on the busbar unit 20. In the step of positioning the jig 400 on the busbar unit 20, the jig 400 may be positioned on an outer surface of the busbar cover 230 or on an outer surface of the busbar body 210.

The step of welding the busbar unit 20 to the electrode lead 120 may include a step in which the busbar unit 20 and the electrode lead 120 form the weld bead 600. In the step in which the busbar unit 20 and the electrode lead 120 form the weld bead 600, thermal energy may be applied to the busbar unit 20 and the electrode lead 120. In the step in which the busbar unit 20 and the electrode lead 120 form the weld bead 600, at least one of the busbar body 210 and the busbar cover 230 and the electrode lead 120 may form the weld bead 600.

The step in which the busbar unit 20 and the electrode lead 120 form the weld bead 600 may include a step of forming a first weld bead 610 in which a portion of the busbar body 210 and a portion of the electrode lead 120 are melted and joined.

The method of manufacturing the battery module according to an embodiment of the present disclosure may include a step of forming a second weld bead 620 in which a portion of the busbar body 210 and a portion of the busbar cover 230 are melted and joined.

Only specific examples of implementations of certain embodiments are described. Variations, improvements and enhancements of the disclosed embodiments and other embodiments may be made based on the disclosure of this patent document.

What is claimed is:

1. A battery module comprising:
a plurality of battery cells stacked in a first direction, wherein each of the plurality of battery cells includes a cell body and an electrode lead protruding from the cell body;
a busbar including a busbar body in which a plurality of busbar slits are formed, the electrode leads of the plurality of battery cells passing through the plurality of busbar slits, wherein the electrodes of the plurality of battery cells are respectively inserted into the plurality of busbar slits and are bent in the first direction to overlap with each other; and
a first weld bead formed by melting and joining a portion of the busbar body and a portion of the electrode lead, the first weld bead extending in the first direction.

2. The battery module of claim 1, further comprising a busbar cover configured to cover the busbar body.

3. The battery module of claim 2, wherein the portion of the electrode lead of each of the plurality of battery cells is positioned between the busbar body and the busbar cover.

4. The battery module of claim 3, wherein the busbar cover forms a stepped portion based on a number of the electrode leads positioned between the busbar body and the busbar cover.

5. The battery module of claim 2, wherein a portion of the busbar cover and the busbar body are in contact with and weld-joined to each other.

6. The battery module of claim 2, further comprising a second weld bead extending in a longitudinal direction of each of the plurality of busbar slits.

7. The battery module of claim 1, wherein the first weld bead includes a plurality of first weld beads.

8. The battery module of claim 7, wherein the plurality of first weld beads are arranged to be spaced apart from each other in a longitudinal direction of each of the plurality of busbar slits.

9. The battery module of claim 8, wherein the longitudinal direction is a width direction of the cell body.

10. The battery module of claim 1, wherein the electrode lead includes:
a proximal end portion extending from the cell body; and
a distal end portion bent and extended from the proximal end portion in the first direction.

11. The battery module of claim 10, wherein the first weld bead couples the busbar body to the distal end portion.

12. The battery module of claim 11, wherein the distal end portions of the two electrode leads respectively extending from two adjacent cell bodies of the plurality of cell bodies are overlapped and coupled by the first weld bead.

13. A method of manufacturing a battery module assembling a plurality of battery cells and a busbar unit, each of the plurality of battery cells including a cell body and an electrode lead protruding from the cell body, the busbar unit including a busbar body in which a plurality of busbar slits are formed, the method comprising:
coupling the busbar unit to the battery cell; and
welding the electrode lead to the busbar unit,
wherein coupling the busbar unit to the battery cell comprises:
inserting the electrode lead into the busbar slit; and
bending the electrode lead.

14. The method of claim 13, wherein bending the electrode lead comprises bending the electrode lead in the busbar slit in a first direction in which the cell bodies of the plurality of battery cells are stacked.

15. The method of claim 14, wherein welding the electrode lead to the busbar unit comprises melting and joining a portion of the electrode lead and a portion of the busbar body to form a first weld bead extending in the first direction.

16. The method of claim 13, wherein the busbar unit further includes a busbar cover covering the cell body and the electrode lead.

17. The method of claim 16, wherein coupling the busbar unit to the battery cell further comprises covering the electrode lead by the busbar cover.

18. The method of claim 16, further comprising:
melting and joining a portion of the busbar body and a portion of the busbar cover to form a second weld bead extending in a longitudinal direction of the busbar slit.

19. The method of claim 13, wherein welding the electrode lead to the busbar unit comprises positioning a jig on the busbar unit after the electrode lead is bent in the busbar slit.

20. The method of claim 19, wherein the jig includes:
a jig horizontal portion extending in a direction in which the cell bodies of the plurality of battery cells are stacked; and
a jig vertical portion extending in a longitudinal direction of the busbar slit.
